(19) United States
(12) Patent Application Publication
(10) Pub. No.: US 2008/0066874 A1
(43) Pub. Date: Mar. 20, 2008

(54) High efficiency water desalinator

(76) Inventors: Mohinder Singh Bhatti, Amherst, NY (US); Ilya Reyzin, Williamsville, NY (US); Shrikant Mukund Joshi, Williamsville, NY (US)

Correspondence Address: DELPHI TECHNOLOGIES, INC., M/C 480-410-202, PO BOX 5052, TROY, MI, 48007, US

(21) Appl. No.: 11/523,416

(22) Filed: Sep. 19, 2006

(51) Int. Cl. B01D 1/22

(52) U.S. Cl. 159/5

(57) ABSTRACT

A water desalinator includes a plurality of spaced tubes for establishing wet channels with fins extending between adjacent tubes for establishing a plurality of dry channels. A blower blows air through the dry channels, and air is bled from the dry airstreams to form wet airstreams flowing through the wet channels. A saline water tank is in fluid communication with the tubes to introduce saline water into the wet channels. Heat is extracted from the dry airstreams and transferred to the saline water, causing it to evaporate into the wet airstreams. By rejecting the heat out of the wet airstream in a condensation chamber, fresh water condenses out of the wet airstream and deposits into a water tank.

### BACKGROUND OF THE INVENTION

1. Field of the Invention

The subject invention relates to desalinating water, and more specifically to desalinating water using the principles of evaporative cooling.

2. Description of the Prior Art

Water desalination refers generally to a process of removing soluble salts from water to render it suitable for drinking, irrigation, or industrial uses. Since much of the Earth's water is salt laden, desalination process are important in providing fresh water to areas that have insufficient supply. One of the most common methods for desalinating water is known as distillation, where salt water is heated to evaporate the water into vapor, leaving the salt behind. The vapor is then condensed in a separate container. The problem is that the heat for evaporation requires high energy. One solution is found in U.S. Pat. No. 4,267,022 to Pitcher, where a vacuum pump is used to lower pressure in the evaporator, so that less heat is required to evaporate the water. Although less energy is required to evaporate the water, energy is still required to operate the pump.

Another system is shown in U.S. Pat. No. 7,007,453 to Maisotsenko et al., where salt water is carried by a stack gas and deposited into a reservoir. Ambient air is driven into an evaporative cooler to evaporate the water. The ambient airstream is then directed into a condenser where the fresh water condenses out of the airstream. While this solution takes advantage of using the energy of ambient air to evaporate water, it requires the presence of the stack gas, which is provided in Maisotsenko by a power production system.

There is need for an improved water desalination system and method that overcomes these and other disadvantages.

### SUMMARY OF THE INVENTION AND ADVANTAGES

The invention provides an assembly for producing a condensate of desalinated water. The assembly includes at least one tube extending in a longitudinal direction from a front to a back. The tube establishes at least one wet channel for receiving a wet airstream. At least one fin extends from the at least one tube, defining a dry channel. A dry airstream is received within the dry channel and flows longitudinally from the front toward the back. The at least one tube includes a bleeder for bleeding air from the dry airstream to create the wet airstream. A saline water tank is in fluid communication with the at least one tube for introducing saline water to the at least one wet channel. Heat is extracted from the dry airstream to evaporate the saline water into the wet airstream. A condensation chamber is in fluid communication with the wet and dry airstreams. A condensate of desalinated water is produced when heat is rejected from the wet airstream within the condensation chamber.

The invention operates by conveying intake air into the dry airstream, and bleeding a fraction of the intake air into the wet airstream. The wet airstream is then exposed to saline water. Heat is extracted from the dry airstream and transferred to the saline water to cause it to evaporate into the wet airstream. The extracted heat is then rejected out of the wet airstream, and desalinated water is condensed out of the wet airstream.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an isometric view of an assembly according to a first exemplary embodiment of the present invention;

FIG. 2 is a psychrometric chart showing the relationship between temperature and humidity of air flowing through the assembly of FIG. 1;

FIG. 3 is an exploded view of the assembly of FIG. 1;

FIG. 4 is an isometric view of an assembly according to a second exemplary embodiment of the present invention;

FIG. 5 is a psychrometric chart showing the relationship between temperature and humidity of air flowing through the assembly of FIG. 4;

FIG. 6 is an exploded view of the assembly of FIG. 4; and

FIG. 7 is a flow chart demonstrating a method of producing desalinated water according to the present invention.

### DETAILED DESCRIPTION OF THE INVENTION

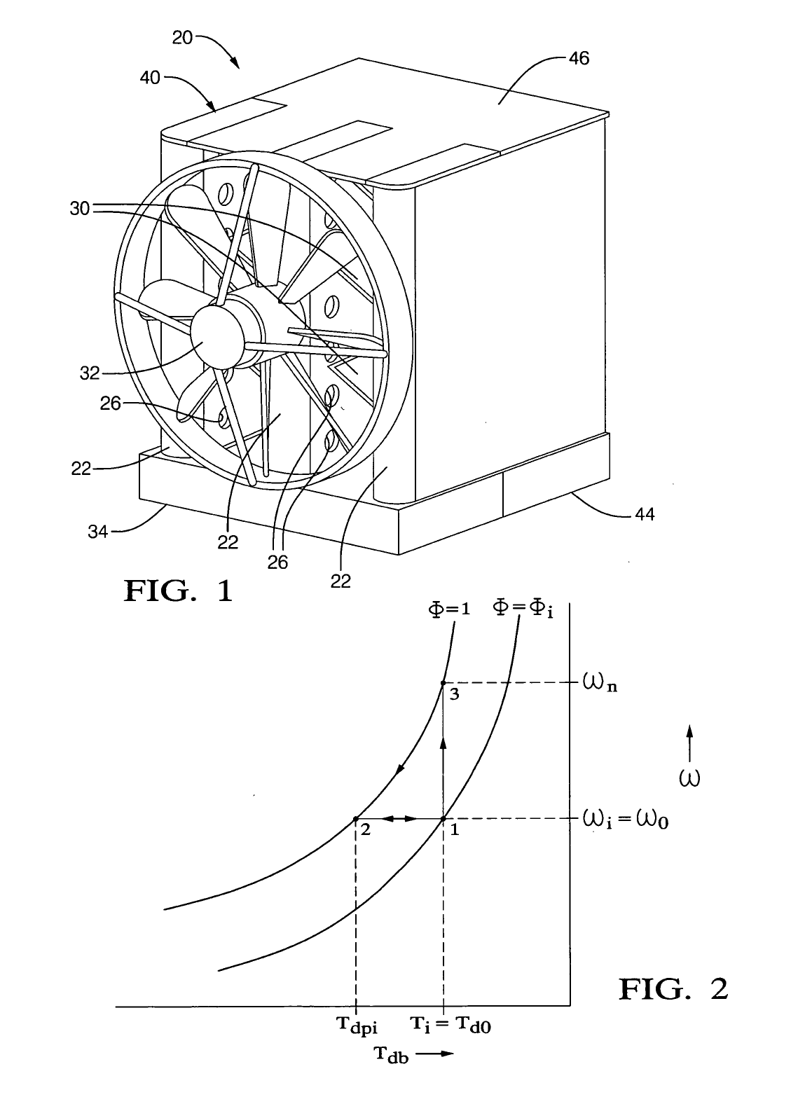

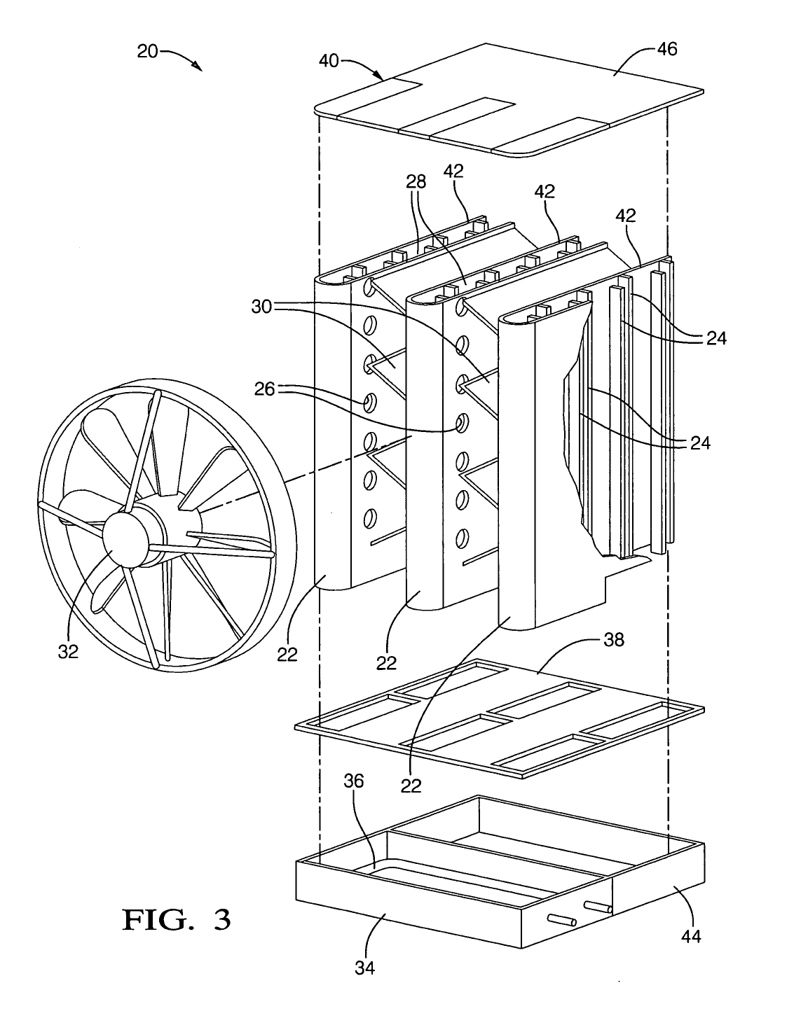

Referring to the Figures, wherein like numerals indicate corresponding parts throughout the several views, a water desalinating assembly is shown generally at 20. According to a first exemplary embodiment, shown in FIGS. 1 and 3, the assembly 20 includes a plurality of tubes 22 spaced from one another. The tubes 22 extend in a vertical direction from a lower end to an upper end, and in a horizontal direction from a front to a 20 back. A plurality of wet channels is established within the tube 22 walls for carrying a wet airstream, which will be discussed in more detail below. An array of ribs 24 extend inwardly from opposite sides of the tube 22 walls, the ribs 24 running along the height of the tubes 22 from the lower end to the upper end. The ribs 24 are further spaced from one another along the tubes 22 from the front to the back. A bleeder is defined along each tube 22 for receiving 25 air into the wet airstream. According to the first exemplary embodiment, the bleeder comprises a plurality of orifices 26 spaced vertically along the front of the tubes 22. A wicking material 28 lines the tubes 22 and extends upward from the lower end of the tubes 22. The wicking material 28 draws liquid into the wet channels by surface tension effect. According to the first exemplary embodiment, the wicking material 28 covers only a portion of the tubes 22, starting at the front, and terminating intermediate the front and the back of the tubes 22.

A plurality of fins 30 extend between adjacent tubes 22 and run between the front and the back of the tubes 22. A plurality of dry channels is established between the adjacent tubes 22 along the fins 30 for carrying a dry airstream flowing therein from the front toward the back. Air in the dry airstream is bled into the wet airstream through the aforementioned orifices 26. The air for the dry and wet airstreams can be provided, for example, by a blower 32.

According to the first exemplary embodiment, a saline water tank 34 surrounds the lower end of only the portion of the tubes 22 covered by the wicking material 28. The capillary action of the wicking material 28 draws saline water into the wet channels, where it is evaporated into the wet airstream. Referring to the psychrometric chart of FIG. 2, the latent heat of evaporation is provided by the dry airstream, reducing its temperature from the incoming temperature, labeled Tᵢ, to a lower temperature, labeled T_{dpi}, which corresponds to the dew point temperature. Simultaneously, the absolute humidity of the wet airstream increases from its incoming level, labeled ωᵢ, to a higher absolute humidity of ωₕ. It should be noted that the air entering the assembly 20 has an initial relative humidity of Φᵢ, and the separated airstreams reach a saturation point, Φ=1. A heating element 36 is placed within the saline water tank 34. If the ambient air temperature is not able to evaporate a sufficient amount of saline water, the heating element 36 may be used to boil saline water into vapor, thereby enhancing its introduction into the wet airstream. A tank cover 38 is placed beneath the plurality of fins 30 to fluidly isolate the saline water tank 34 from the dry channels, but simultaneously allow the wet channels to be in fluid communication with the saline water tank 34.

A plate 40 covers the upper end of the tubes 22. This directs the flow of the wet airstream in the wet channels from the front toward the back, such that the wet airstream flows parallel to the dry airstream. A condensation chamber 42 is located downstream from the wicking material 28. The condensation chamber 42 receives the airstreams and produces a condensate of desalinated water. According to the first exemplary embodiment, the condensation chamber 42 consists of the portion of the tubes 22 extending rearwardly from the end of the wicking material 28. The wet airstream flowing through these tubes 22 runs alongside the dry airstream. The latent heat of condensation is rejected from the wet airstream back to the dry airstream. This reduces the temperature of the wet airstream to T_{dpi}, which triggers condensation. The vapor condenses into droplets which form in the air, and film which forms along the ribs 24 in the condensation chamber 42. The condensed water falls into the potable water tank 44 provided below. To assist condensation, a thermoelectric module 46 lines the plate 40 to provide additional cooling of the wet airstream. It should be noted that, since the dry airstream is already at the dew point temperature, only a small amount of additional cooling is needed. Thus, according to the first exemplary embodiment, the air exiting the wet channels leaves at a temperature T_{dpi} and absolute humidity ωₒ, and the air exiting the dry channels leaves at a temperature T_{do} and absolute humidity ωₒ. According to the psychrometric chart, Tᵢ=T_{do} and ωᵢ=ωₒ.

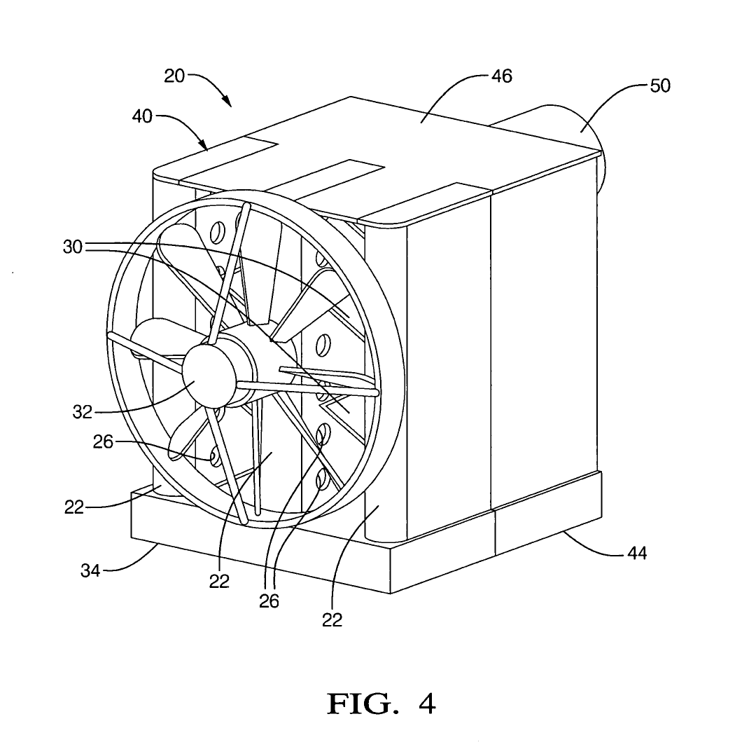

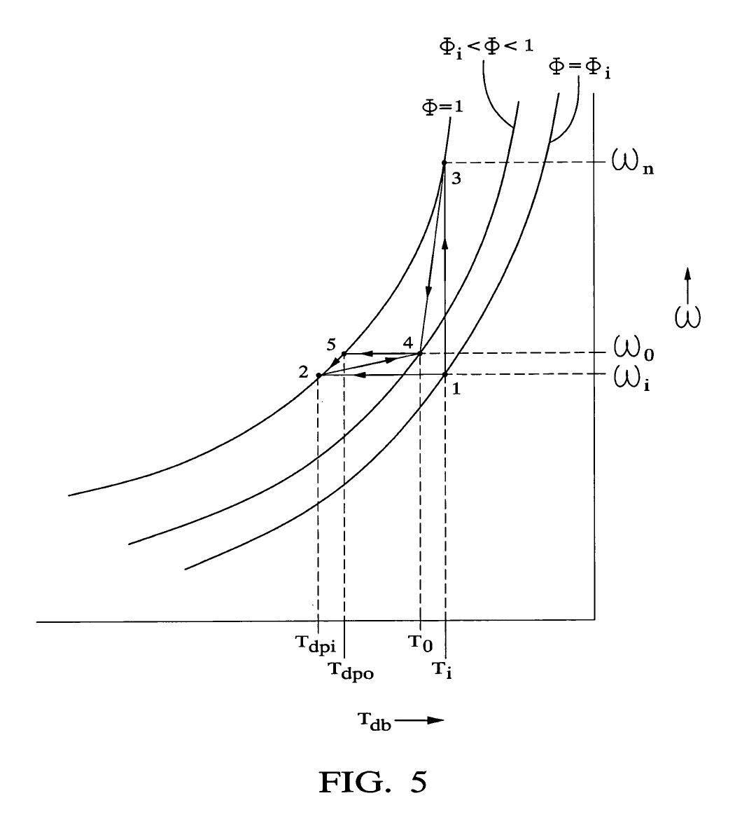

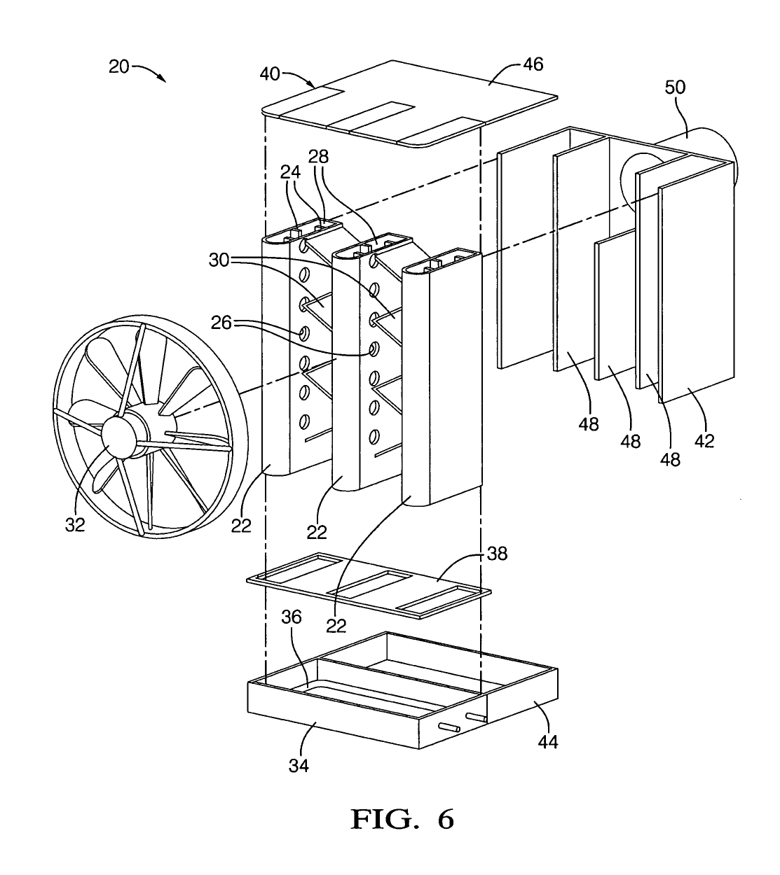

An assembly 20 according to a second exemplary embodiment, shown specifically in FIGS. 4 and 6, is similar to that of the first exemplary embodiment. However, the wicking material 28 lines the entire tubes 22, and the saline water tank 34 25 completely surrounds the lower end of the tubes 22. The condensation chamber 42 extends rearward, from the back of the tubes 22, allowing the wet and dry airstreams to commingle. The entire condensation chamber 42 is surrounded by the thermoelectric module 46 for supplemental cooling. Referring to the psychrometric chart of FIG. 5, intake air enters the dry channels at temperature Tᵢ, absolute humidity ωᵢ, and relative humidity Φᵢ. The wet airstream is bled off from the dry airstream similar to the first exemplary embodiment, and evaporates the saline water to reach an absolute humidity ωₕ and a relative humidity Φ=1. Evaporation of the saline water requires heat, which comes from the dry airstream, which results in a temperature T_{dpi}, and a relative humidity Φ=1. T_{dpi} corresponds to the dew point temperature. When the wet and dry airstreams commingle in the condensation chamber 42, their humidity and temperature converge to achieve a temperature of Tₒ, absolute humidity ω₀, and relative humidity of Φ. The temperature Tₒ is lower than the initial temperature Tᵢ. The commingled airstream is then subjected to additional cooling by virtue of the thermo-electric module 46, which further reduces the temperature of the airstream to T_{dpo}. The condensation forms on the cool air molecules within the commingled airstream, thereby creating fog. Hence, the condensation chamber 42 of the present embodiment is referred to as a fog chamber. In addition, a plurality of condensing surfaces 48 is provided within the condensation chamber 42 to collect the condensed water and transport it to the potable water tank 44 below. The cool air then exits through an exhaust port 50.

It should be appreciated that the scale of the water desalination assembly 20 can be varied to accommodate the necessary design parameters. Hence, the assembly 20 could be constructed as a large, stationary unit for producing water for an entire community. Alternatively, the assembly 20 could be constructed as a small unit for supplying water to a smaller group, or to an individual. In addition, the assembly 20 operates without need for mechanical components (such as the pumps and the stack gas found in the prior art) it may be constructed as a portable unit, and therefore useful, for example, in emergency situations.

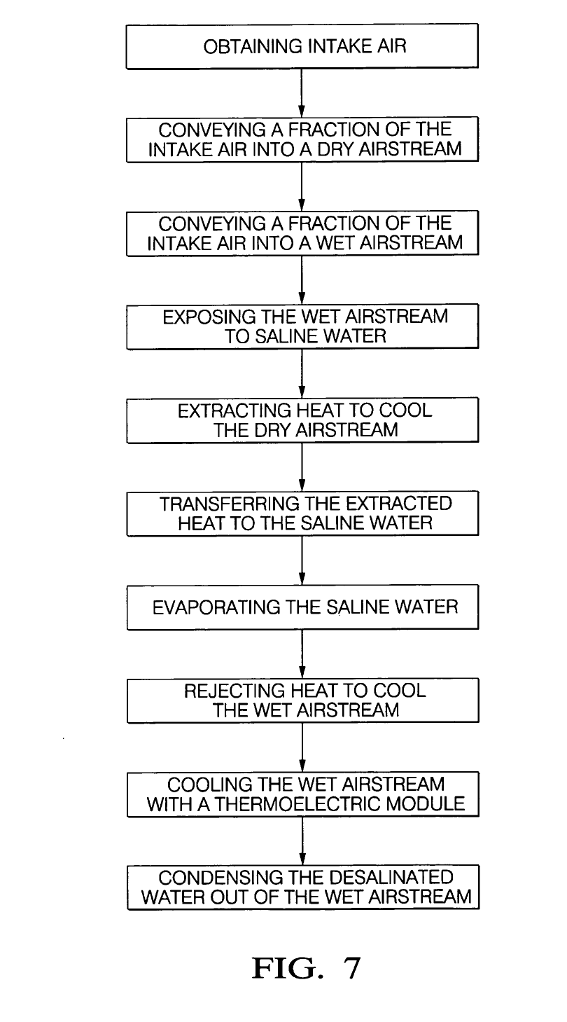

Accordingly, the invention includes a method of desalinating water described with reference to the flow chart of FIG. 7. First, intake air is conveyed into a dry airstream, and a fraction of the intake air is bled into a wet airstream. The wet airstream is exposed to saline water, which is evaporated into the wet airstream by extracting heat from the dry airstream. This can be achieved, for example, by wicking saline water into contact with the wet channels by surface tension effect. The wet and dry airstreams flow parallel to one another while the extracted heat is transferred to the saline water. Desalinated water is then condensed out of the wet airstream by rejecting the extracted heat. In accordance with the first exemplary embodiment, the wet and dry airstreams are maintained separately from one another, and the rejected heat is therefore transferred back to the dry airstream. The wet airstream is further cooled by a thermo-electric module 46 to enhance condensation.

In accordance with the second exemplary embodiment, the wet and dry airstreams are commingled and then cooled by the thermoelectric module 46 to reject the extracted heat and cause condensation.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An assembly for desalinating water comprising;
at least one tube extending longitudinally from a front to a back for establishing at least one wet channel,
at least one fin extending from said at least one tube defining at least one dry channel for a dry airstream flowing longitudinally from said front toward said back,
said at least one tube defining a bleeder for bleeding air from said at least one dry channel to said at least one wet channel,
a saline water tank in fluid communication with said tube for adding saline water to said at least one wet channel for evaporation to create a wet airstream therein by abstracting heat from air in said at least one dry channel, and
a condensation chamber in fluid communication with the wet and dry airstreams for producing a condensate of desalinated water by rejecting heat from the wet airstream.

2. An assembly as set forth in claim 1 including a pair of said tubes spaced apart from one another and wherein said at least one dry channel is defined between said pair of said tubes.

3. An assembly as set forth in claim 2 wherein said tubes extend from a lower end at least partially surrounded by said saline water tank to an upper end.

4. An assembly as set forth in claim 3 further including a plate covering said upper end of said tubes to direct the flow of the wet airstream in said wet channels from said front toward said back and parallel to the dry airstream.

5. An assembly as set forth in claim 4 wherein said plate includes a thermo-electric module for further enhancing condensation of desalinated water.

6. An assembly as set forth in claim 5 wherein said thermo-electric module surrounds said condensation chamber.

7. An assembly as set forth in claim 4 wherein said tubes include a wicking portion and a wicking material extending from said lower end of said wicking portion of said tubes and into said saline water tank for drawing saline water into said wet channels for evaporation.

8. An assembly as set forth in claim 7 wherein said condensation chamber comprises an extension of said tubes extending longitudinally and rearwardly from said wicking portion.

9. An assembly as set forth in claim 8 wherein said saline water tank surrounds said wicking portion of said tubes.

10. An assembly as set forth in claim 7 wherein said condensation chamber extends from said back of said tubes.

11. An assembly as set forth in claim 10 wherein said condensation chamber commingles the wet and dry airstreams downstream from said back of said tubes.

12. An assembly as set forth in claim 10 wherein said wicking material lines said tubes from said front to said back.

13. An assembly as set forth in claim 10 wherein said saline water tank completely surrounds said lower end of said tubes.

14. An assembly as set forth in claim 3 further including a tank cover below said at least one fin for fluidly isolating said saline water tank from said dry channels.

15. An assembly as set forth in claim 3 further including a heating element disposed within said saline water tank for boiling saline water into vapor for introduction into said wet channels and the wet airstream therein.

16. An assembly for desalinating water comprising;
a plurality of tubes spaced from one another and extending vertically from a lower end to an upper end and horizontally from a front to a back for establishing a plurality of wet channels,
said tubes each including an array of ribs extending inwardly from opposite sides of said tubes and extending vertically from said lower end to said upper end,
said ribs spaced from one another horizontally along said tubes from said front to said back,
a plurality of fins each extending between adjacent tubes at an angle relative to said tubes and extending between said front and said back of said tubes for establishing a plurality of dry channels for a dry airstream flowing therein from said front toward said back,
said tubes defining a plurality of orifices spaced vertically along said front of said tubes for bleeding air from said dry channels to said wet channels,
a saline water tank surrounding said lower end of at least a portion of said tubes,
a wicking material extending from said lower end of said portion of said tubes for drawing saline water into said wet channels for evaporation to create a wet airstream therein by abstracting heat from air in said dry channels,
a heating element disposed within said saline water tank to boil saline water into vapor for enhancing introduction into said wet channels and the wet airstream therein,
a tank cover beneath said plurality of fins for fluidly isolating said saline water tank from said dry channels,
a plate covering said upper end of said tubes to direct the flow of the wet airstream in said wet channels from said front toward said back parallel to the dry airstream,
a condensation chamber downstream from said wicking material for receiving the wet and dry airstreams to produce a condensate of desalinated water by rejecting heat from the wet airstream,
a thermoelectric module lining said plate for further enhancing production of the condensate of desalinated water, and
a potable water tank positioned beneath said condensation chamber for receiving the condensate of desalinated water.

17. An assembly as set forth in claim 16 wherein said condensation chamber comprises an extension of said tubes.

18. An assembly as set forth in claim 17 wherein said saline water tank surrounds the portion of said tubes lined with said wicking material.

19. An assembly as set forth in claim 16 wherein said condensation chamber extends from said back of said tubes.

20. An assembly as set forth in claim 19 wherein said saline water tank completely surrounds said lower end of said tubes.

21. An assembly as set forth in claim 19 wherein said thermoelectric module surrounds said condensation chamber to produce a commingled airstream having a lower temperature than air entering said dry channels.

22. An assembly as set forth in claim 19 wherein said condensation chamber further includes at least one condensing surface extending there within for development of the condensate of desalinated water.

23. A method of desalinating water comprising;
conveying intake air into a dry airstream,
bleeding a fraction of the intake air into a wet airstream,
exposing the wet airstream to saline water,
extracting heat from the dry airstream,
transferring the extracted heat to the saline water and evaporating the saline water into the wet airstream, and
rejecting the extracted heat out of the wet airstream and condensing desalinated water out of the wet airstream.

24. A method as set forth in claim 23 further defined as flowing the wet and dry airstreams parallel to one another while transferring the extracted heat from the dry airstream to the wet airstream.

25. A method as set forth in claim 24 further defined as maintaining the wet and dry airstreams separate from one another while rejecting the extracted heat.

26. A method as set forth in claim 25 wherein said rejecting the extracted heat is further defined as rejecting the extracted heat back to the dry airstream.

27. A method as set forth in claim 25 further defined as cooling the wet airstream with a thermo-electric module while rejecting the extracted heat to enhance condensation.

28. A method as set forth in claim 24 further defined as commingling the wet and dry airstreams while rejecting the extracted heat.

29. A method as set forth in claim 28 further defined as cooling the commingled airstream with a thermoelectric module while rejecting the extracted heat to enhance condensation.

30. A method as set forth in claim 24 wherein said exposing is further defined as wicking saline water into communication with the wet airstream for evaporation into the wet airstream.
